(19) United States
(12) Patent Application Publication
(10) Pub. No.: US 2017/0041702 A1
(43) Pub. Date: Feb. 9, 2017

(54) ADJUSTABLE WRISTBAND USING MAGNETS

(71) Applicants: Hyon Bae, Oakland, CA (US); Mika Neonen, Helsinki (FI); Anson Liang, Santa Clara, CA (US); Xing Guangxing, Shenzhen (CN); Angela Pan, Santa Clara, CA (US)

(72) Inventors: Hyon Bae, Oakland, CA (US); Mika Neonen, Helsinki (FI); Anson Liang, Santa Clara, CA (US); Xing Guangxing, Shenzhen (CN); Angela Pan, Santa Clara, CA (US)

(21) Appl. No.: 15/297,067

(22) Filed: Oct. 18, 2016

Related U.S. Application Data
(63) Continuation-in-part of application No. 15/179,790, filed on Jun. 10, 2016.
(60) Provisional application No. 62/180,492, filed on Jun. 16, 2015.

(51) Int. Cl. H04R 1/10; A44C 5/20; A45C 13/10; A44C 5/00; H04R 1/02; A45C 11/24

(52) U.S. Cl. CPC H04R 1/1091; H04R 1/028; A45C 11/24; A45C 13/1069; A44C 5/003; A44C 5/20; H04R 1/1058; A44D 2203/00

(57) ABSTRACT

A combination of a bracelet and a Bluetooth wireless headphone is disclosed. The Bluetooth headphone is stored inside the bracelet, and the bracelet can be worn on the wrist of the user. The Bluetooth headphone has two small earbuds and a media play controller. The bracelet comprises two housings at two ends of an elongated body of the bracelet. The bracelet forms a loop to be worn on a wrist by having a magnet coupled with a ferrous material on the housing.

### CROSS-REFERENCE TO RELATED APPLICATION(S)

This application is a continuation-in-part of U.S. patent application Ser. No. 15/179,790, filed Jun. 10, 2016, and entitled “Bluetooth Wireless Headphone Bracelet.” U.S. Patent Application Ser. No. 15/179,790 claims priority of U.S. Provisional Application Ser. No. 62/180,492, filed Jun. 16, 2015, and entitled “Bluetooth Wireless Headphone Bracelet.” This application incorporates U.S. patent application Ser. No. 15/179,790 and U.S. Provisional Application Ser. No. 62/180,492 in their entirety by reference for all purposes.

This application also claims priority under 35 U.S.C. §119(e) of the U.S. Provisional Patent Application Ser. No. 62/244,017, filed Oct. 20, 2015 and titled, ADJUSTABLE WRISTBAND USING MAGNETS,” which is also hereby incorporated by reference in its entirety for all purposes.

### FIELD OF THE INVENTION

The present invention relates to the field of wristbands. More specifically, the present invention relates to size adjustable wristbands using magnets.

### BACKGROUND OF THE INVENTION

A typical wristband comprises mechanical structures for size adjustments. The size is generally fixed once the user's adjustment is done, which lacks the ability of dynamic size adjustment.

### SUMMARY OF THE INVENTION

A device for and a method of making a size adjustable wristband using magnets are disclosed herein. In some embodiments, the wristband comprises a body, a first housing, a second housing with a ferrous metal frame, and a magnet for a size-adjustable function.

In some embodiments, a combination of a bracelet and a Bluetooth wireless headphone is provided. In some embodiments, a Bluetooth headphone is stored inside the bracelet, and the bracelet can be worn on the wrist of a user. In some embodiments, a Bluetooth headphone has two small earbuds with high sound quality speakers inside.

In an aspect, a wireless headphone container comprises a bracelet having a cavity structured to store a wireless headphone and a magnet at a first end of the bracelet coupled with a first housing at a second end of the bracelet forming a loop. In some embodiments, the magnet is located at a sidewall of a second housing of the bracelet. In other embodiments, the magnet is enclosed within a second housing of the bracelet. In some other embodiments, the magnet is exposed at the sidewall of a second housing, such that the magnet is in direct contact with the first housing when forming the loop. In some embodiments, the second housing is coupled with the first housing through magnetism. In other embodiments, the first housing is made of ferrous metal. In some other embodiments, the wireless headphone comprises earbuds and one or more cables configured to be entirely stored in the bracelet. In some embodiments, the cavity comprises at least two openings at the first end and the second end of the bracelet. In other embodiments, the at least two openings is structured to fit earbuds and a media play controller at the first end and the second end.

In another aspect, a wristband comprises an elongated member having a cavity for storing an electronic device and a magnet at a first end of the elongated member configured to couple with a second end of the elongated member to form a loop structure. In some embodiments, the electronic device comprises a headphone. In other embodiments, the cavity comprises two spaces at the first end and the second end respectively. In some other embodiments, the elongated member comprises two housings. In some embodiments, the two housings are structured to store an earbuds and a media play controller. In other embodiments, the magnet comprises a rare earth magnet. In some other embodiments, the rare earth magnet comprises a neodymium magnet.

In another aspect, a method of making a wearable electronic device comprises forming a container wearable on a wrist, wherein the container has a loop structure maintained by using a magnetic component, forming a headphone, and storing the headphone in the container.

In some embodiments, the container comprises an elongated body forming the loop. In other embodiments, the elongated body comprises two housing at two terminals of the elongated body. In some other embodiments, the method further comprises opening the loop by reducing a magnetic coupling force with one of the at least two housings.

In another aspect, a wireless headphone container comprises a bracelet and a wireless headphone having earbuds and one or more cables configured to fit into an opening of the bracelet. In some embodiments, the opening comprises a first cavity and a second cavity. In other embodiments, the first cavity is at a proximal end of the bracelet and the second cavity is at a distal end of the bracelet. In some other embodiments, the bracelet comprises a channel connecting the first cavity and the second cavity. In some embodiments, the channel is configured to have a size for storing a cable. In other embodiments, the first cavity has a shape matches a shape of a control unit of the headphone. In some other embodiments, the second cavity has a shape structured to store the earbuds.

In another aspect, a wearable electronic device comprises a container wearable on a wrist and an audio unit configured to be stored in the container. In some embodiments, the audio unit comprises a headphone. In other embodiments, the headphone comprises a Bluetooth headphone. In some other embodiments, the audio unit is stored inside the container, such that the audio unit is invisible when stored. In some embodiments, the container comprises a bracelet. In some other embodiments, the container comprises a first cavity having a shape for storing a control unit. In some other embodiments, the container comprises a second cavity having a shape for storing two earbuds. In some embodiments, the container comprises a body in a loop structure. In some other embodiments, the loop structure is able to be pulled to open. In some other embodiments, the loop structure comprises two ends form an overlapping section at a close state.

In another aspect, a method of making a wearable headphone comprises forming a container wearable on a wrist, forming a headphone, and storing the headphone in the container. In some embodiments, the method further comprises forming at least two cavities and a slit on the container. In other embodiments, the one of the at least two cavities has a shape for storing a control unit. In some other embodiments, the other of the at least two cavities has a shape for storing earbuds. In some embodiments, the slit has a shape for storing an audio cable.

Other features and advantages of the present invention will become apparent after reviewing the detailed description of the embodiments set forth below.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

Figures attached illustrate a construction and a use of the bracelet and the Bluetooth wireless headphone in accordance with some embodiments.

FIG. 1 illustrates a perspective view of a wearable electronic accessory device in accordance with some embodiments.

FIG. 2 illustrates several views of the wearable electronic accessory device in accordance with some embodiments.

FIG. 3 illustrates constructions of the device in accordance with some embodiments.

FIG. 4 illustrates a control unit in accordance with some embodiments.

FIG. 5 illustrates a cross sectional view of a headphone storage inside a body of a cuff in accordance with some embodiments.

FIG. 6 illustrates a method of using the wearable electronic accessory device in accordance with some embodiments.

FIG. 7 illustrates a method of making a wireless headphone bracelet in accordance with some embodiments.

FIGS. 8A and 8B illustrate an adjustable wristband in accordance with some embodiments.

### DETAILED DESCRIPTION OF THE PREFERRED EMBODIMENT

Reference is made in detail to the embodiments, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals vary from one implementation to another and from one developer to another. Moreover, it is appreciated that such a development effort can be complex and time-consuming, but is nevertheless a routine undertaking of engineering for those of ordinary skill in the art having the benefit of this disclosure.

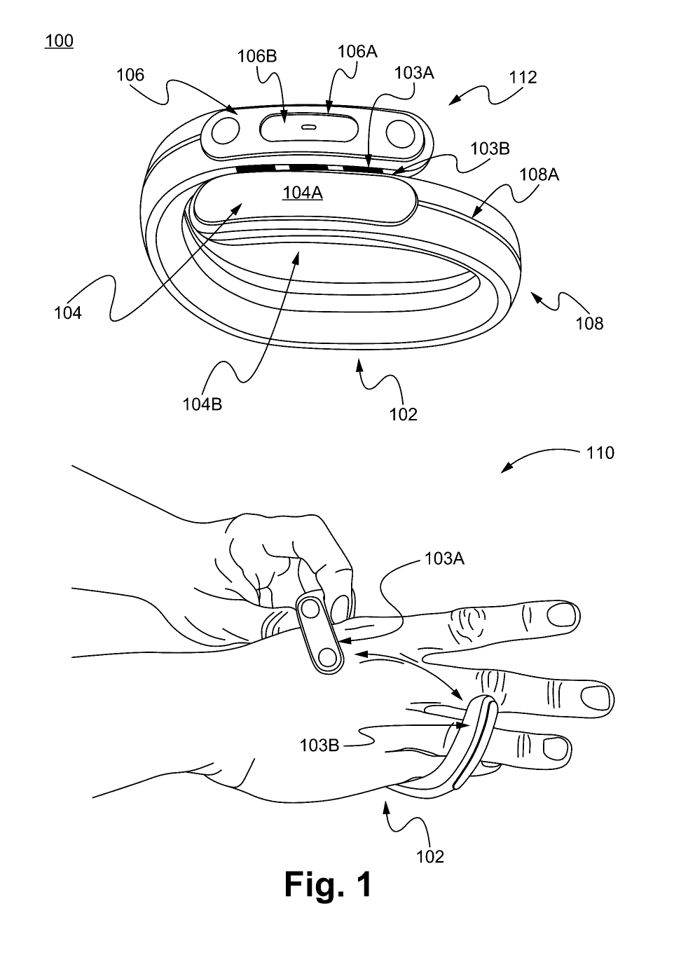

FIG. 1 illustrates a perspective view of a wearable electronic accessory device 100 in accordance with some embodiments. In some embodiments, the device 100 comprises a body 102 having a first side 104, a second side 106, and a connecting unit 108 connecting the first side 104 and the second side 106. Each of the first side 104 and the second side 106 contains a container. The container of the first side 104 is configured to have a structure to contain one or more earbuds. In some embodiments, the container of the first side 104 contains one or more cavities having a shape that is able to be snug-fit and immobilize the earbuds, so that the earbuds are retained and do not fall out when the cavities are facing toward the force of gravity. A cover 104A covers the cavities of the container at the first side 104. The cover 104A is able to be an earbuds housing cover. In some embodiments, the container of the second side 106 comprises a control unit 106A.

The device 100 comprises an elastic body 102, which can be pulled to open as in a wearing open state 110. In some embodiments, the elastic body 102 has a spring like function, allowing the elastic body 102 to spring back to a closed wearing state 112. In some embodiments, one or more magnets or materials that attract to a magnetic force are on the two sides 103A and 103B of the body to keep a loop shape of the body 102.

In some embodiments, the device 100 comprises a headphone including the earbuds, a cable, and the control unit 106A. The headphone is able to be a Bluetooth headphone.

In some embodiments, the device is formed as a bracelet having the body 102 in a loop structure. Two housing spaces 104B and 106B on the loop, one for storing the earbuds at the first side 104 and the other one for storing the control unit of the headphone at the second side 106. A slit 108A at the middle of the bracelet at the connecting unit 108 to store the cable of the headphone.

In some embodiments, electronic chips and batteries are embedded inside the loop structure of the body 102. The electronic chips are able to be used to track location, monitor movement, perform a Bluetooth connection, store music and data, and other functions by using GPS, memory storage unit, CPU, and other electronic hardware.

In some embodiments, the loop structure of the body 102 is able to have different designs. A person of ordinary skill in the art would appreciate that various appearances, shapes, colors, and materials can be used. For example, the body 102 is able to be made of materials such as rubber, metal, aluminum, gold, leather, and plastic. The device 100 is able to have various colors such as silver, black, red, blue, pink, and gold. The device 100 is able to have various shapes and designs such as, round, flat, thin, slim, rectangular, and other shapes. Similarly, the two housing spaces 104B and 106B for storing the earbuds and the control unit are able to be made using the above mentioned materials and made into a shape and color as mentioned above.

In some embodiments, the two housing spaces 104B and 106B are located at the top of the loop. In other embodiments, one or both of the two housing spaces 104B and 106B are located at different positions of the loop, for example, the bottom, the left side, or the right side.

In some embodiments, the housing cover 104A covers the housing space 104B for storing the earbuds. The housing cover 104A functions as a gate to store the earbuds inside the bracelet. The earbuds housing cover is able to be made into different designs, appearances, shapes, colors, and materials.

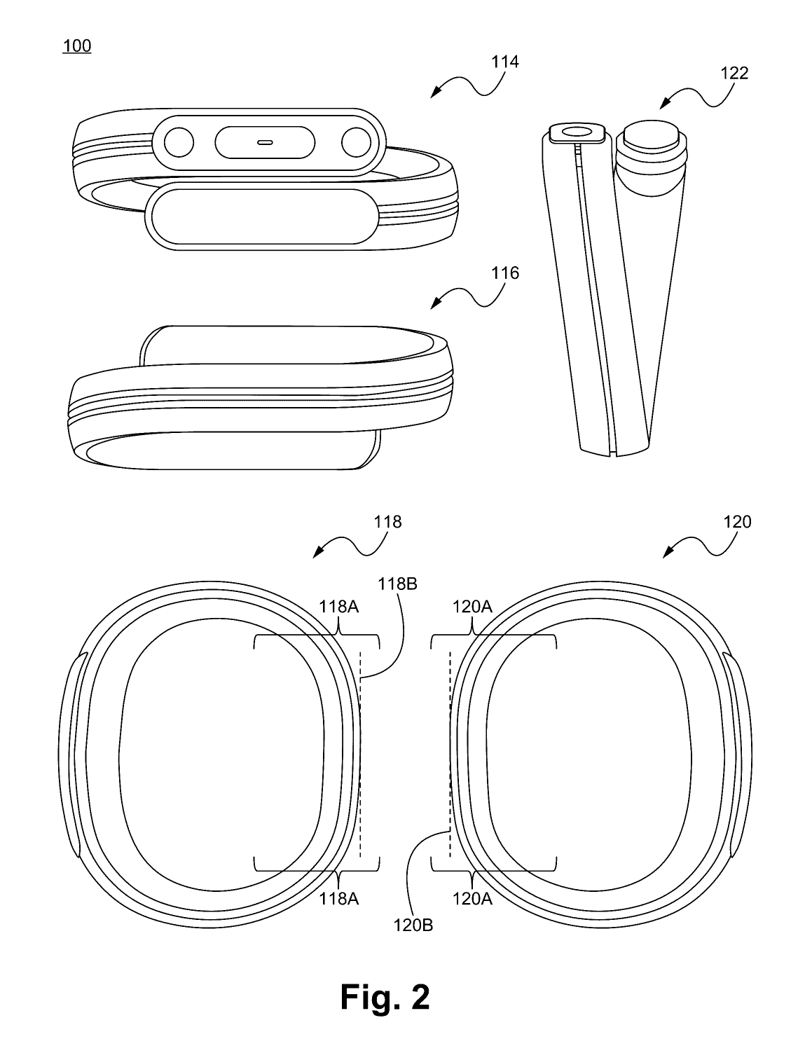

FIG. 2 illustrates several views of the wearable electronic accessory device 100 in accordance with some embodiments. Item 114 shows a top view of the device 100, which shows that the two ends of the device 100 are coupled to each other and immobilized by its material property. Alternatively, the two ends of the device 100 are coupled to each other and immobilized by using a magnetic force. Item 116 shows a bottom view of the device 100. Item 118 shows a right side view of the device 100. The sections 118A and 120A comprise a thinness section or a reduced thickness of the loop to enhance the comfort to the user when wearing the device 100. In some embodiments, the sections 118A and 120A are substantially flat on a plane 118B and 120B such that the user is able to rest his/her wrist against a surface. Item 118 shows a right side view of the device 100. Item 120 shows a left side view of the device 100. Item 122 shows a front view of the device 100.

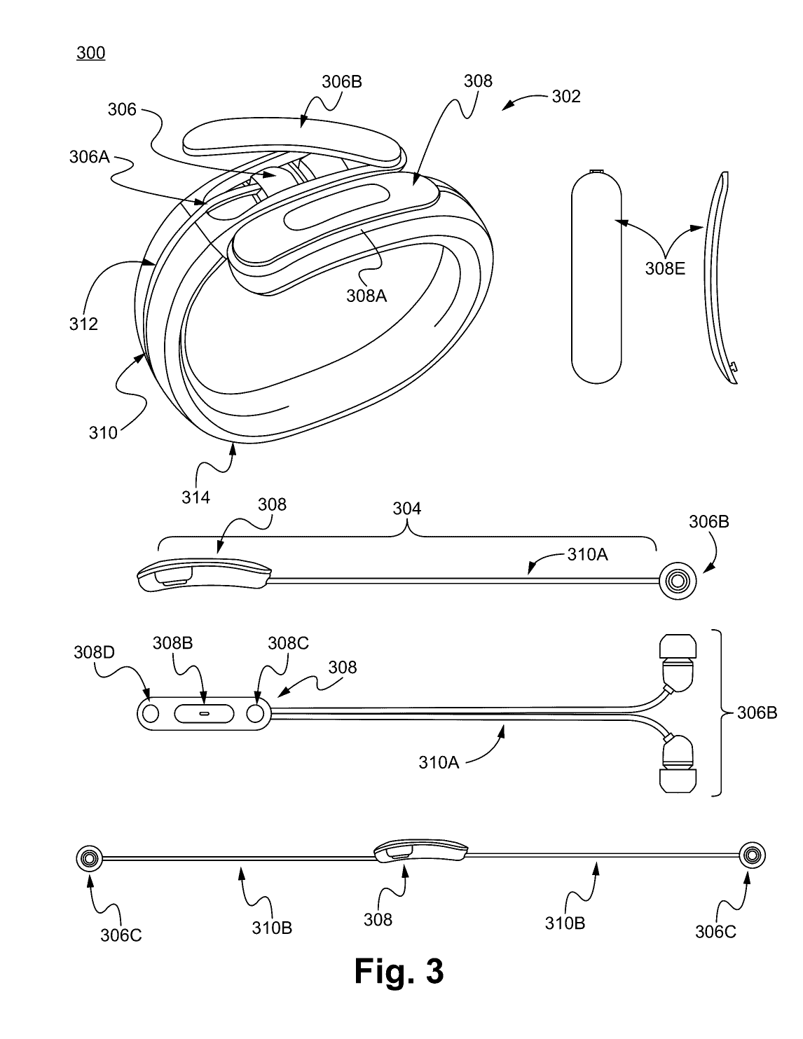

FIG. 3 illustrates constructions 300 of the device 100 in accordance with some embodiments. Item 302 shows that a headphone 304 couples with a cuff 314, which is the same or similar construction of the body 102 in FIG. 1. The headphone 304 comprises a control unit 308 and one or more earbuds 306, which are coupled/connected via a cable 310. When the headphone 304 is stored in the cuff 314, two apertures 306A and 308A serve as housings for the earbuds 306 and the control unit 308, which are configured to be snug-fit inside the apertures 306A and 308A. The cable 310 is stored inside the slit 312. In some embodiments, the cable 310 is completely inside the slit 312, so that the cable 310 is invisible from outside. In some embodiments, the cable 310 comprises two parallel cables, with one of the parallel cables for a left channel volume and the other parallel cable for a right channel volume. A cover 308E conceals and covers the aperture 308A, which can be made of metal or metallic color. The cover 308E is able to comprise a bolt structure to be clipped on a hole on the cuff 314.

In some embodiments, two cables 310A are extending out from a same side of the control unit 308. In some other embodiments, two cables 310B extend out from opposite sides of the control unit 308, such that the earbuds 306C extend out at different directions, which serves as a cable tangling prevention structure. A person of ordinary skilled in the art would appreciate that the cables 310 are able to be manufactured to come out of the control unit 308 in various directions.

In some embodiments, the headphone 304, which is able to be a Bluetooth headphone in some embodiments, has one control unit 308 and two earbuds 306. The two earbuds 306 are connected to the control unit 308 by two cables 310. The control unit 308 has electronic chips and batteries inside, such that the headphone 304 wirelessly connects to a music source device (such as a iPhone or a MP3 player) via Bluetooth. A person of ordinary skilled in the art would appreciate that the headphone 304 is able to connect with a music source device wirelessly or via another cable. In some embodiments, the headphone 304 is able to have different structures and be made of different materials. A person of ordinary skilled in the art would appreciate that various appearances, shapes, colors, and materials can be used. For example, the headphone 304 can be made of materials such as rubber, metal, aluminum, gold, leather, and plastic. The headphone 304 is able to have various colors such as silver, black, red, blue, pink, and gold. The headphone 304 is able to have various shapes and designs such as, round, flat, thin, slim, rectangular, and other shapes.

In some embodiments, the control unit 308 comprises one or more buttons. In some embodiments, a button 308B is used to turn on/off the power and/or the volume of the headphone 304. In some embodiments, the same button 308B is used to accept/reject phone call and pause/play music. In some embodiments, a button 308C is used to increase the volume. In some embodiments, the same button 308C is used to fast forward to the next song. Similarly, a button 308D is used to decrease the volume. In some embodiments, the same button 308D is used to fast rewind to the beginning of the current song and/or the previous song.

In some embodiments, each of the earbuds 306 has a speaker unit inside. In some embodiments, the earbuds 306 are able to have different structures and materials. A person of ordinary skilled in the art would appreciate that various appearances, shapes, colors, and materials can be used. For example, the earbuds 306 can be made of materials such as rubber, metal, aluminum, gold, leather, and plastic. The earbuds 306 are able to have various colors such as silver, black, red, blue, pink, and gold. The earbuds 306 are able to have various shapes and designs such as, round, flat, thin, slim, rectangular, and other shapes.

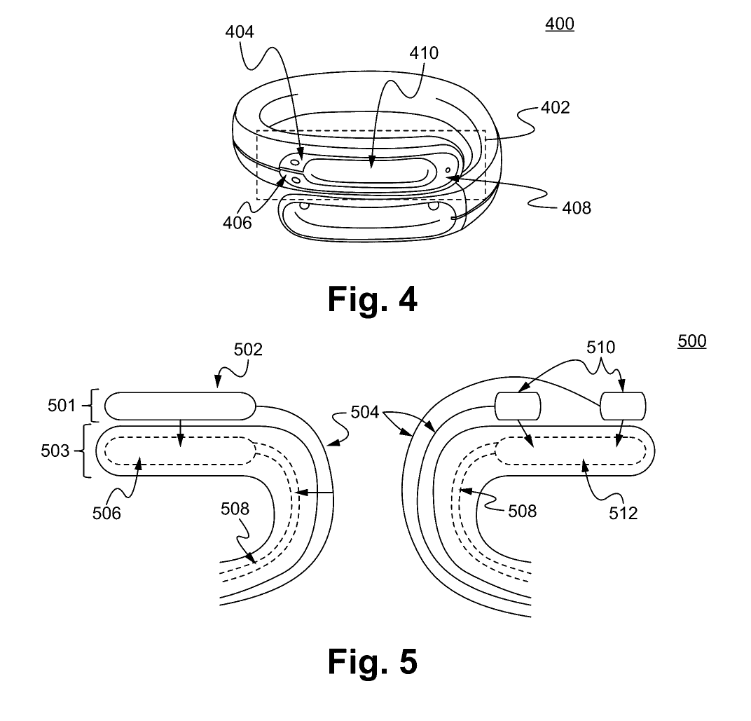

FIG. 4 illustrates a control unit 400 in accordance with some embodiments. In some embodiments, the control unit 400 comprises a set of volume buttons 404 and 406 for volume control, a power control 408, and a biometrics identification device 410 such as a fingerprint scanner.

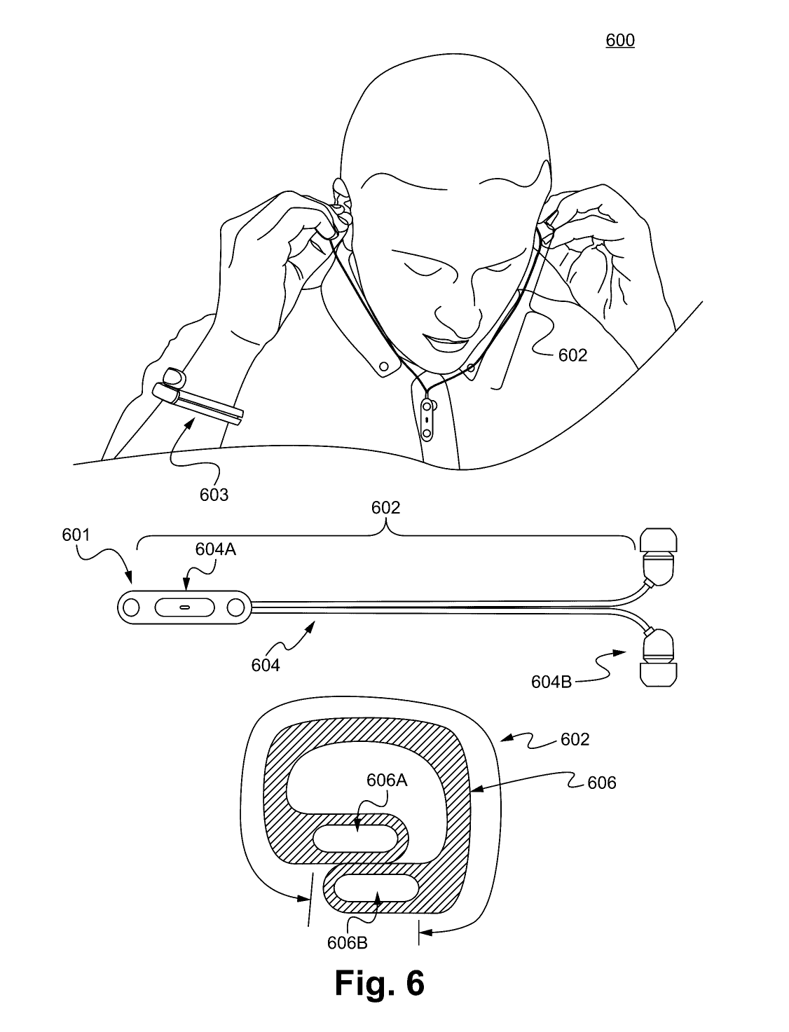

FIG. 5 illustrates a cross sectional view of a headphone storage 500 inside a body of a cuff in accordance with some embodiments. In some embodiments, the headphone 501 comprises a control unit 502 and earbuds 510 connected to the control unit 502 via a cable 504. The body of the cuff 503 comprises a first space 506 for storing the control unit 503, a second space 512 for storing the earbuds 510, and a channel 508 for storing the cable 504.

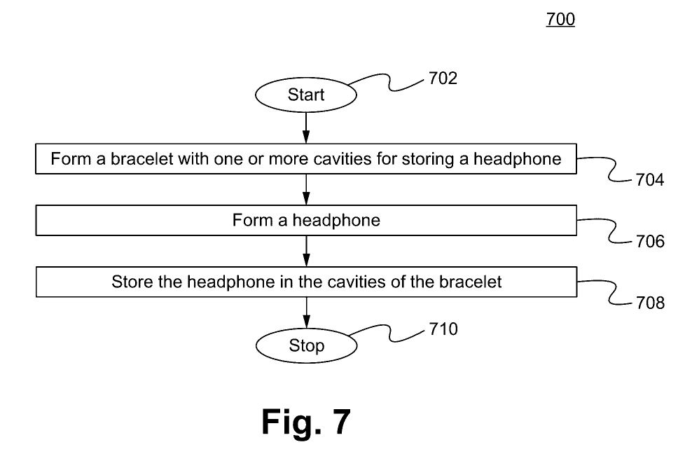

FIG. 6 illustrates a method 600 for using the wearable electronic accessory device 100 in accordance with some embodiments. A headphone 601 is able to be stored in the cuff 606 to be worn on a wrist 603. Similar to the device 100 (FIGS. 1 and 2) described above, the headphone 601 comprises a control unit 604A, a cable 604, and the earbuds 604B. The cable 604 has a length 602 long enough to hang under the chin and short enough to be stored in the cuff 606 (e.g., a bracelet). The control unit 604A is able to be stored in the first end 606A and the earbuds 604B are able to be stored in the second end 606B. In some embodiments, the length 602 is between 10 cm and 20 cm. In some embodiments, the length 602 is between 15 cm and 30 cm.

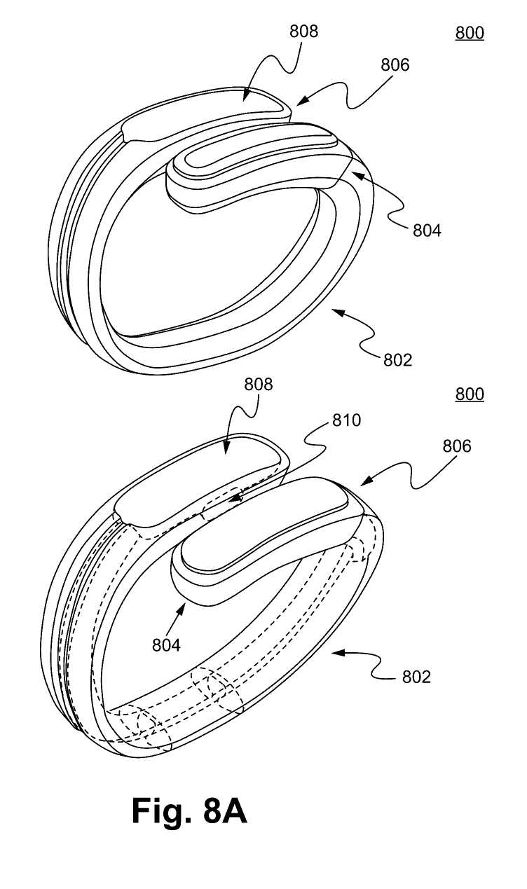

FIG. 7 illustrates a method 700 of making a wireless headphone bracelet in accordance with some embodiments. The method starts at a Step 702. At a Step 704, a bracelet is formed with one or more cavities having a shape configured to store a headphone. In some embodiments, the headphone comprises a wireless headphone. The headphone is able to contain a control unit, earbuds, and a cable connecting the control unit and the earbuds. The forming of the bracelet is able to be done by molding, CNC cutting and drilling, and other typical manufacturing methods and devices to make the bracelet. One or more covers for the cavities are formed. The cover is able to contain a ball joint structure to clip on a socket structure on or around the cavities, such that the cover is able to be fixed on the bracelet.

At a Step 706, a headphone is formed. In some embodiments, the headphone is structured to have a cable length long enough to be worn from one side of the ear under the chin to the other side of the ear and short enough to be stored inside the bracelet. In some embodiments, the length of the cable does not form a repeating loop when the headphone is stored inside the bracelet.

At a Step 708, the headphone is stored in the bracelet. In some embodiments, the control unit of the headphone is stored in a proximal side of the one of the cavities of the bracelet and the earbuds are stored at a distal side of the cavities of the bracelet. In some embodiments, the cavities for storing the earbuds are connected and form a number eight shape, such that each of the earbuds is able to be separately stored together. The method is able to stop at a Step 710.

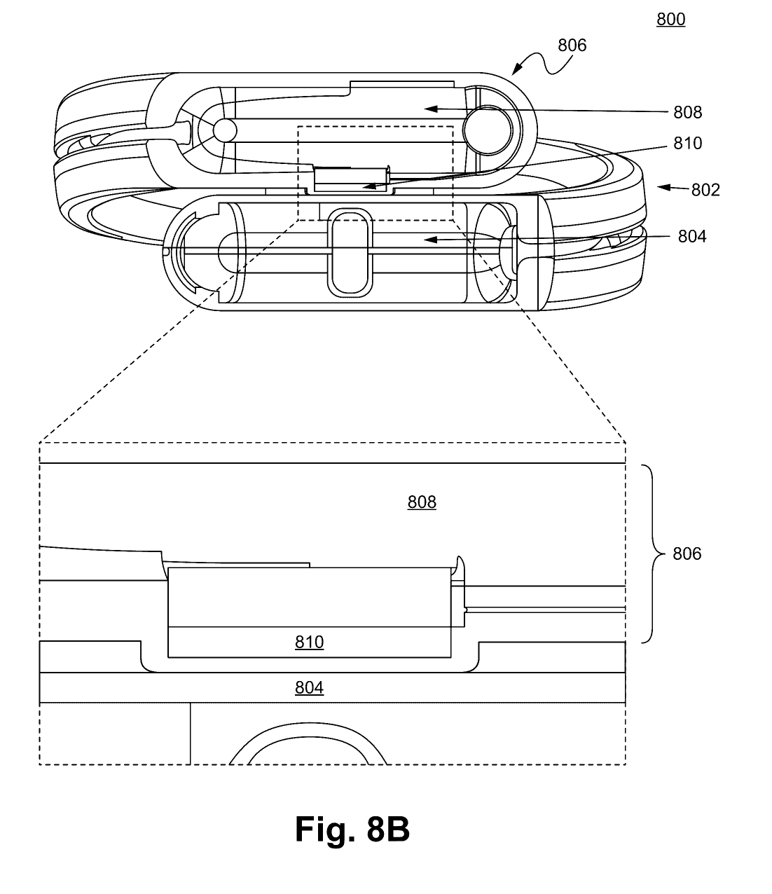

FIGS. 8A and 8B illustrate an adjustable wristband 800 in accordance with some embodiments. In some embodiments, the wristband 800 comprises a body 802. The body 802 of the wristband 800 is able to contain two housings 804 and 806. The housings 804 and 806 are able to contain cavities for storing a media playing controller and the earbuds respectively in each of the housings 804 and 806. In some embodiments, the two housings 804 and 806 are constructed to be in shapes of round, flat, thin, slim, and/or rectangular. In some embodiments, the body 802 comprises an elongated member, which forms a completed loop by twisting/bending the body allowing the two terminals to be coupled with each other.

In some embodiments, the housings 804 and/or 806 partly or in their entirety comprise ferrous metals. A person of ordinary skill in the art will appreciate that ferrite in steel or ferromagnetic attracts magnets. The ferrite content of steel or stainless steel attracts to magnets. Ferrous metals are able to refer to all metals with Ferrite content. In some embodiments, the housing 804 and/or 806 partly or in their entirety comprise nonferrous metals. In some embodiments, the housing 804 and/or 806 are made by the same materials (e.g., silicone, ABS (acrylonitrile butadiene styrene), and any other polymeric materials) as well as the body 102 of the wristband.

In some embodiments, the magnets 810 for a size-adjustable structure/mechanism is embedded between the sidewalls of housings 804 and 806. In other embodiments, the magnet 804 is embedded in one sidewall of the housing 804 or 806, which magnetically couples with the metallic part of the counterpart housing 804 or 806. In some embodiments, the entire housings 804 and/or 806 are made of ferrous metal, such that the magnets 804 are able to couple with a section of the body 802 (e.g., a housing) forming a completed loop.

In some embodiments, the magnet 810 forms a dynamic size adjustment mechanism of the wristband, because the magnet is able to attach to any location/part of the sidewall of the housing 804. Such feature/structure makes the wristband size-adjustable by attaching the magnet to different locations on the housing 804. The dynamic size adjusting mechanism gradually and dynamically changes the size of the body 802 according to the force/pressure applied on the body, which is an advanced feature for providing comforts to the users. The magnets 810 are able to be in different designs, appearances, shapes, colors, and magnetic forces (e.g., neodymium magnets, rare earth magnets, and typical magnets).

In some embodiments, the magnet 810 for size-adjustable structure is embedded parallel to and in the side wall of the housing 806. The magnet 810 is magnetically coupled with the ferrous metal frame of housing 804. In some embodiments, the magnet 810 is in direct contact with the housing 804. In some other embodiments, the magnet 810 is enclosed in the housing 806 (e.g., not exposed) and magnetically coupled with the housing 804 through the side wall of the housing 806.

In some embodiments, the magnetic force between the magnet 810 and the ferrous metal frame housing 804 is at least twice of the magnetic force between a magnet and a typical steel plate. Such construction requires more than twice of the force of pulling a magnet apart from a steel plate than the force of pulling the magnet 810 apart from the housing 804.

In some embodiments, the magnet is embedded inside the housing 810 and is not exposed so it does not have direct contact with the housing 804. In some embodiments, the material that forms the housing 806 is different from the material that forms the housing 804. For example, the housing 806 is able to be made of rubber, which has a higher coefficient of friction than the coefficient of friction of the housing 804 that is made of metals. A person of ordinary skill in the art appreciates that any other materials (e.g., polyurethane, polyethylene, polypropylene, acrylonitrile butadiene styrene (ABS), and any other polymers and plastics; metals; and leathers) are able to be used to construct the housings 804 and 806.

In some embodiments, the housing 806 is in direct contact with the housing 804, which provides a higher friction between the surfaces, such that relative motions and movements are restricted, reduced, or prevented.

In some embodiments, the wristband and its various components comprise different designs, appearances, shapes, colors, and materials. For example, the wristband and its various components are able to comprise different materials like rubber, metal, aluminum, gold, leather, plastic and other materials. In some embodiments, the wristband comprises different colors like sliver, black, red, blue, pink, gold, and other colors. In some other embodiments, the wristband and its various components comprise different shapes and designs like round, flat, thin, slim, rectangular, and other shapes.

In utilization, a magnetic force is used for coupling and fixing the relative positions of the housings of the wristband. The magnetic force is able to be generated by a magnet coupling with another magnet or a ferric/ferrous material as part of the housing of the wristband.

In operation, the headphone is placed into the bracelet, the control unit is placed in the associated housing of the loop structure, the cables are placed into the channel and wrap around the bracelet, the earbuds are placed into the associated housing on the loop structure of the bracelet, the earbuds housing cover is closed, and the magnet is coupled with the housing to form a loop structure for the user to easy put on and take off.

In use, the earbuds housing cover is opened, the earbuds are taken out of the loop structure of the bracelet and the cables are taken out from the channel and unwrapped around the bracelet, and the control unit is taken out of the loop structure of the bracelet.

The present invention has been described in terms of specific embodiments incorporating details to facilitate the understanding of principles of construction and operation of the invention. Such reference herein to specific embodiments and details thereof is not intended to limit the scope of the claims appended hereto. It is readily apparent to one skilled in the art that other various modifications can be made in the embodiment chosen for illustration without departing from the spirit and scope of the invention as defined by the claims.

What is claimed is:

1. A wireless headphone container comprising:
a) a bracelet having a cavity structured to store a wireless headphone; and
b) a magnet at a first end of the bracelet coupled with a first housing at a second end of the bracelet forming a loop.

2. The wireless headphone container of claim 1, wherein the magnet is located at a sidewall of a second housing of the bracelet.

3. The wireless headphone container of claim 2, wherein the magnet is enclosed within a second housing of the bracelet.

4. The wireless headphone container of claim 2, wherein the magnet is exposed at the sidewall of a second housing, such that the magnet is in direct contact with the first housing when forming the loop.

5. The wireless headphone container of claim 2, wherein the second housing is coupled with the first housing through magnetism.

6. The wireless headphone container of claim 1, wherein the first housing is made of ferrous metal.

7. The wireless headphone container of claim 1, wherein the wireless headphone comprises earbuds and one or more cables configured to be entirely stored in the bracelet.

8. The wireless headphone container of claim 1, wherein the cavity comprises at least two openings at the first end and the second end of the bracelet.

9. The wireless headphone container of claim 8, wherein the at least two openings are structured to fit earbuds and a media play controller at the first end and the second end.

10. A wristband comprising:
a) an elongated member having a cavity for storing an electronic device; and
b) a magnet at a first end of the elongated member configured to couple with a second end of the elongated member to form a loop structure.

11. The wristband of claim 10, wherein the electronic device comprises a headphone.

12. The wristband of claim 10, wherein the cavity comprises two spaces at the first end and the second end respectively.

13. The wristband of claim 10, wherein the elongated member comprises two housings.

14. The wristband of claim 10, wherein the two housings are structured to store an earbuds and a media play controller.

15. The wristband of claim 10, wherein the magnet comprises a rare earth magnet.

16. The wristband of claim 15, wherein the rare earth magnet comprises a neodymium magnet.

17. A method of making a wearable electronic device comprising:
a) forming a container wearable on a wrist, wherein the container has a loop structure maintained by using a magnetic component;
b) forming a headphone; and
c) storing the headphone in the container.

18. The method of claim 17, wherein the container comprises an elongated body forming the loop.

19. The method of claim 17, wherein the elongated body comprises two housing at two terminals of the elongated body.

20. The method of claim 19, further comprising opening the loop by reducing a magnetic coupling force with one of the at least two housings.
